(19) United States
(12) Patent Application Publication
(10) Pub. No.: US 2003/0178444 A1
(43) Pub. Date: Sep. 25, 2003

(54) Apparatus and method for dispensing oral hygiene solutions

(76) Inventors: Yitzchak Brusowankin, North Miami Beach, FL (US); Michael Einhorn, Aventura, FL (US)

Correspondence Address: DAVID W. BARMAN, 1101 NE 176 TERRACE, NORTH MIAMI BEACH, FL, 33162, US

(21) Appl. No.: 10/104,788

(22) Filed: Mar. 22, 2002

(51) Int. Cl. B67D 1/07

(52) U.S. Cl. 222/192

(57) ABSTRACT

An apparatus and method for the dispensing of dental hygiene solutions.

### SUMMARY OF THE INVENTION

This invention relates to the dispensing of dental hygiene solutions. More particularly, this invention refers to an apparatus and method for the dispensing of dental hygiene solutions.

### BACKGROUND OF THE INVENTION

As our society has grown more complex, certain basic elements of personal care have gone largely neglected. The liquid soap dispenser is a common feature in virtually every public restroom. It is clean, convenient, and promotes good hygiene. These dispensers have gained such popularity that now, many homes have dispensers not only for liquid hand soap, but also for shower soap and shampoo as well. These dispensers are easy to use and promote good personal hygiene.

Most people, as a whole, do not spend the time or effort on dental hygiene that is required. Furthermore, many people who have difficulty controlling halitosis do not have a way to conveniently access oral solutions. We live in a society where convenience is the most important feature of every element of our lives. Most municipal water supplies are fluorinated in an effort to provide people with a quick and easy method for adding this important aid to dental hygiene. However, with the recent popularity of bottled water, even the fluoride of drinking water is not reaching the numbers of people for which it was intended. Dentists all agree, the fluoride that reaches the oral cavity is important, not only in the prevention of dental disorders such as dental carries and periodontal disease, but in the treatment and prevention of halitosis. But the question that now must be addressed is how to get people to use fluorinated dental hygiene products. Furthermore, with a society constantly in flux, how do people access dental hygiene products when away from home? Most dental offices dispense dental hygiene solutions by use of a large bottle with a standard pneumatic pump. Dentists would agree that if there were available an apparatus, suitable for both public and private use, that would dispense dental hygiene solutions, it would greatly improve the overall dental health of our society.

It is an object of the present invention to provide an apparatus and method for dispensing dental hygiene solutions.

It is another object of the present invention to provide an apparatus, which can be used in public and commercial settings.

It is another object of the present invention to provide an apparatus that is easily refillable.

It is another object of the present invention to provide an apparatus that can be adapted for home use.

It is another object of the present invention to provide an apparatus that is simple to build, operate, and maintain.

It is another object of the present invention to provide an apparatus that can be manufactured and maintained in a cost effective manner.

It is another object of the present invention to provide an apparatus that will be a visible reminder to users to maintain good oral hygiene.

### BRIEF DESCRIPTION OF THE DRAWINGS

FIG. 1 is a substantially frontal view showing the cup dispenser, body, and dispensing orifice.

FIG. 2. shows a substantially frontal view showing certain internal elements of the apparatus in a cut away view.

FIG. 3 shows a side view in cut away of the apparatus in which oral hygiene solution is in a suitable container, and is connected to a dispensing valve.

FIG. 4 shows a frontal view in which mounting means and the removable solution container are shown.

FIG. 5 shows another embodiment in which the apparatus is placed on a tabletop or countertop base.

### DETAILED DESCRIPTION OF THE PREFERED EMBODIMENT

The present invention relates to an apparatus and method for dispensing dental hygiene solutions. For the purposes of this invention the term dental hygiene solution refers to any solution commonly used in dental hygiene. These include, but are not limited to mouthwash, fluoride solutions, oral irrigation solutions and the like. It is one embodiment to provide for an apparatus that can be used in a commercial setting. A commercial setting includes but is not limited to restaurants, bars, theaters, arenas, malls, schools or businesses. The inventor intends for a user to be able to access the apparatus in a public setting in order to rinse with an appropriate dental hygiene solution. The apparatus may be in any appropriate size and shape but should contain certain basic elements. These elements include a cup dispenser, an area for placing the cup below the dispensing means, a mechanism for activating a dispensing means, a dispensing means, a solution container, and optionally a way of either mounting to a wall or standing on a tabletop or countertop. The cup dispenser is any suitable means, as are commonly known, for the single dispensing of disposable cups. The mechanism for activating the dispensing means can be any suitable lever, switch or electronic sensor that will activate the dispensing means. The apparatus is intended to have the dispensing mechanism easily accessible to the user. The dispensing means can be a valve or other suitable mechanism by which liquids may be dispensed. In the case of a valve, the dispensing means can be a mechanical, gravitational or electronic dispensing valve. Alternatively, it may be a valve that dispenses a fixed, metered, and adjustable amount of liquid or may dispense an amount determined by the user. The solution container holds the solution in the apparatus in a manner such that the solution can be dispensed through any suitable dispensing means. The solution container may be refillable or disposable. The solution container may be a hard plastic container, soft plastic container or a disposable bag. In one embodiment, the solution container is a disposable bag. The inventor envisions the method of use to be

The method for promoting oral hygiene comprising using an apparatus for dispensing oral hygiene solution comprising;

(a) A housing,

(b) a cup holder,

(c) a dispensing valve, and

(d) a solution container.

And further comprising the steps of

(i) the user removing a cup from said cup holder,

(ii) placing the cup in the appropriate position under said dispensing valve,

(iii) activating said dispensing valve,

(iv) rinsing the oral cavity with said oral hygiene solution,

(v) appropriately disposing of used oral hygiene in a sink or other appropriate receptacle.

The term other appropriate receptacle would include any container or directional means to a container or sink which can remove the used oral hygiene solution from view.

It is the intent of the inventor to display the apparatus in a manner such that the apparatus is easy to use, access, and raise the general awareness of oral hygiene. This method may be used by mounting said apparatus on a wall placed in a holder for use on a countertop or tabletop in a place for public access. The place for public access can include, but is not limited to a public restroom in restaurants, bars, theaters, arenas, malls, schools or businesses. Altenatively, the apparatus is equally suited for private household use.

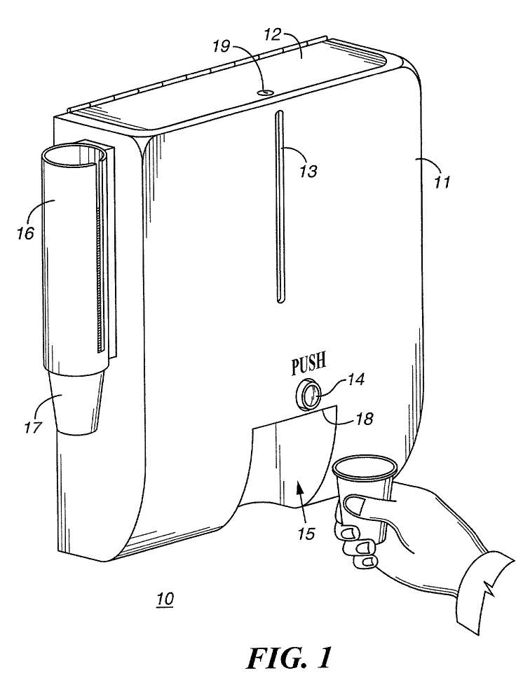

FIG. 1 shows the apparatus 10 with a cup dispenser 16 holding cups 17. The user places a single cup into orifice 15 which is bounded by a lower floor 18 above which the solution is kept. The solution is placed into the apparatus by securing means 19 attached to lid 12. The opening may be a lock, handle or lever. The front wall of the apparatus 11 is preferably formed with an opening 13 which may allow the user to view the level of solution within the apparatus. It will also allow those individuals who maintain the apparatus the ability to ascertain the need for refilling or replacing the solution held within the apparatus.

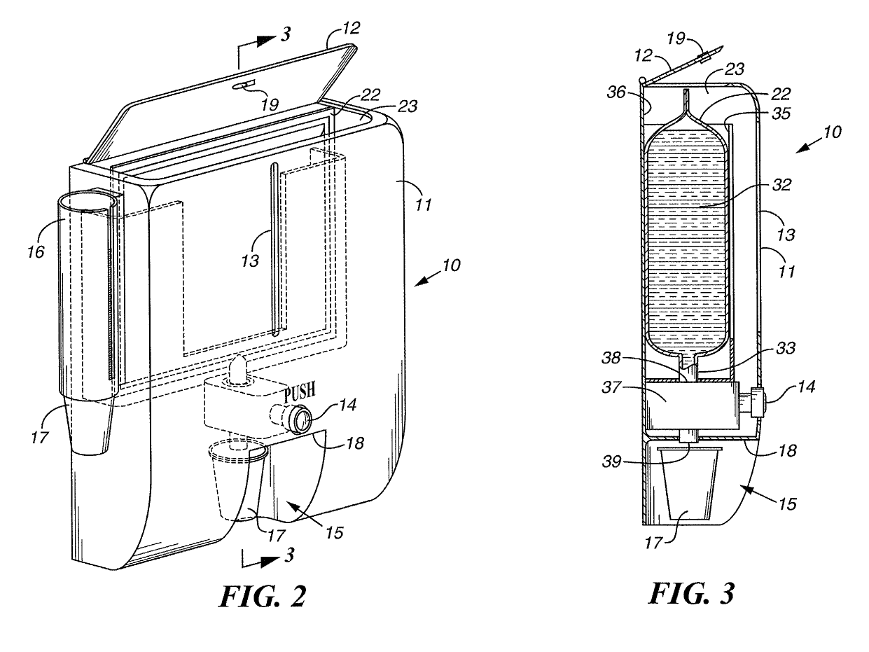

FIG. 2 shows the aforementioned elements and additionally shows securing means 19 on the interior of lid 12. The solution container 22 is placed within the interior of apparatus 10 in cavity 23.

FIG. 3 shows the side view of solution container 22 which holds dental hygiene solution 32. Solution container 22 is held in place within cavity 23 by a the inner wall of support frame 35 and held against the distal wall 36 from the user. The solution container is formed with an appropriate outlet 33. The outlet can be a nozzle. The outlet connects to an inlet 38 which is part of dispensing valve 37, which in turn has outlet 39 for dispensing the solution into a cup 17.

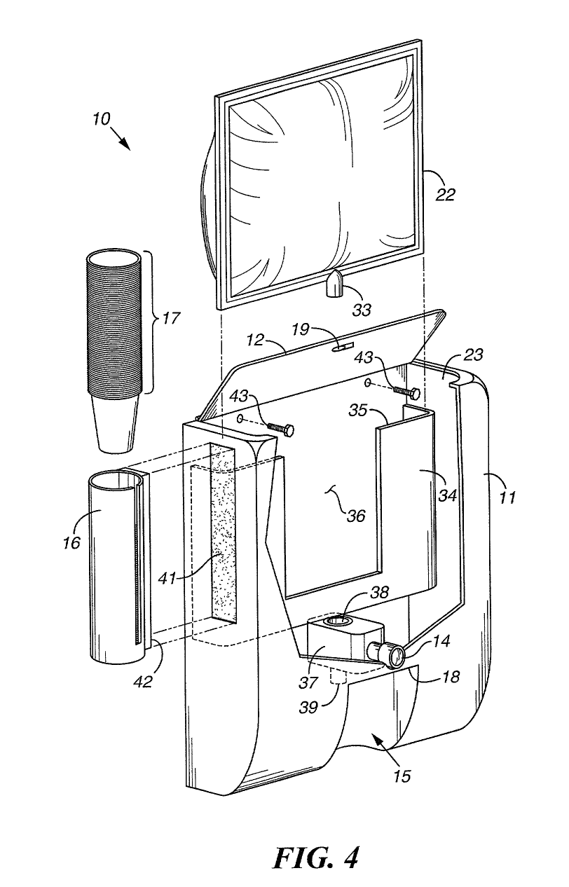

FIG. 4 shows the apparatus with solution container 22 removed from the apparatus 10. Encompassing each of the aforementioned elements and further illustrating mounting means 41 in which side-piece 42 is appropriately formed for mounting. The cup holder may be mounted by Velcro®, or other acceptable means. The figure further shows the support for holding the solution container 34 in which the solution container 22 is placed in the area between the inner wall 35 of the support frame 34 and the back wall 36 of the apparatus. FIG. 2 also illustrates one embodiment in which the apparatus is mounted to the wall with mounting screws 43. The mounting can be by any appropriate means.

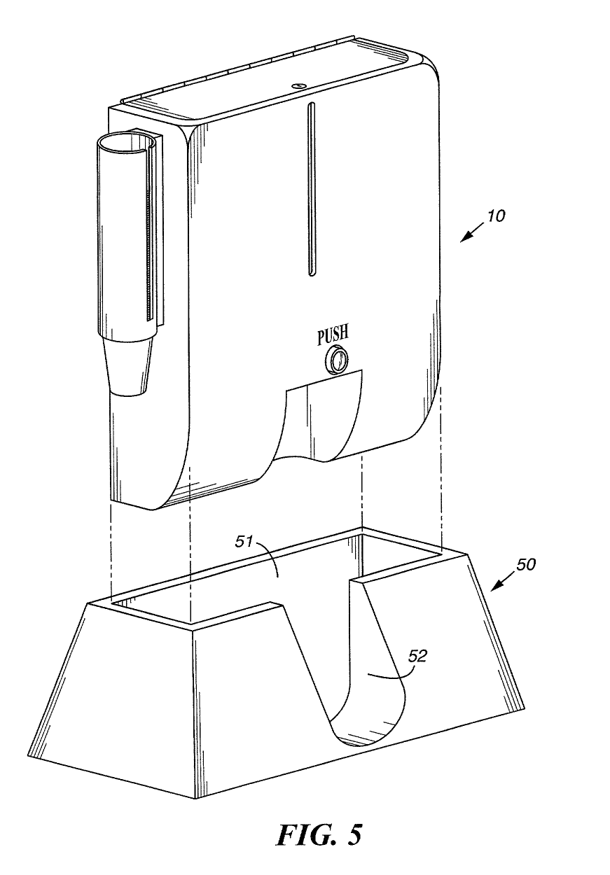

FIG. 5 shows the apparatus 10, which can optionally be used with a base unit 50 that is formed with receiving area 51 and an appropriate opening 52 for accessing the outlet below said dispense valve.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1 An apparatus for dispensing oral hygiene solution comprising;
(a) A housing,
(b) a cup holder,
(c) a dispensing valve, and
(d) a solution container.

2. The apparatus of claim 1 further comprising a means for mounting on a wall.

3. The apparatus of claim 1 further comprising a means for standing alone on a countertop or tabletop.

4. The apparatus of claim 1 wherein said housing is formed to hold a solution container.

5. The apparatus of claim 1 wherein said solution container is disposable.

6. The apparatus of claim 1 wherein said solution container is refillable.

7. The apparatus of claim 1 wherein said solution container is a disposable plastic bag.

8. The apparatus of claim 1 wherein said oral hygiene solution is mouthwash, fluoride solution or suitable oral irrigation solution.

9. The apparatus of claim 1 wherein said dispensing valve is activated by the user from the outside of said apparatus.

10. The apparatus of claim 1 wherein said dispensing valve is mechanical, gravitational or electronic.

11. The apparatus of claim 1 wherein said dispensing valve discharges a metered amount of said oral hygiene solution.

12. The apparatus of claim 1 wherein said dispensing valve discharges an amount determined by the user based on the amount of time said valve is allowed to remain open.

13. A method for promoting oral hygiene comprising using an apparatus for dispensing oral hygiene solution comprising;
(a) A housing,
(b) a cup holder,
(c) a dispensing valve, and
(d) a solution container.
And further comprising the steps of
(j) the user removing a cup from said cup holder,
(ii) placing the cup in the appropriate position under said dispensing valve,
(iii) activating said dispensing valve,
(iv) rinsing the oral cavity with said oral hygiene solution,
(v) appropriately disposing of used oral hygiene in a sink or other appropriate receptacle.

14. The method of claim 13 further comprising mounting said apparatus on a wall.

15. The method of claim 14 further comprising mounting said apparatus in a place for public access.

16. The method of claim 15 wherein said place for public access is a public restroom in restaurants, bars, theaters, arenas, malls, schools or businesses.

17. The method of claim 13 wherein said apparatus is placed in a holder for use on a countertop or tabletop.
